(19) United States
(12) Patent Application Publication
(10) Pub. No.: US 2025/0091564 A1
(43) Pub. Date: Mar. 20, 2025

(54) DEVICE AND METHOD FOR OPERATING AN ELECTROMAGNETIC RAIL BRAKE, ELECTROMAGNETIC RAIL BRAKE AND RAIL VEHICLE

(71) Applicant: KNORR-BREMSE GESELLSCHAFT MIT BESCHRANKTER HAFTUNG, Moedling (AT)

(72) Inventors: Volker Joergl, Breitenfurt (AT); Daniel Tippelt, Wiener Neustadt (AT); Michael Kassan, Steinabruecki (AT); Alexandr Hruby, Modling (AT); Reinhard Loebner, Munich (DE); Ulrich Wermund, Munich (DE); Jens Galander, Dachau (DE)

(21) Appl. No.: 18/901,314

(22) Filed: Sep. 30, 2024

Related U.S. Application Data
(63) Continuation of application No. PCT/EP2023/059865, filed on Apr. 17, 2023.

(30) Foreign Application Priority Data
Apr. 19, 2022 (DE) DE102022109462.6

(51) Int. Cl. B60T 13/74; B60T 17/22

(52) U.S. Cl. CPC B60T 13/748; B60T 13/743; B60T 17/228

(57) ABSTRACT

A device configured to operate an electromagnetic rail brake, comprising: a tank configured to store a hydraulic fluid, a pressure accumulator, a pump device configured to the feed the hydraulic fluid from the tank to the pressure accumulator in order to load the pressure accumulator with a pressure, a brake connection that is coupled or couplable with the pressure accumulator in order to provide a brake pressure to the additional brake device of the rail vehicle; and a suspension connection to a hydraulic device of a two stage suspension, wherein the suspension connection is coupled or couplable with the pressure accumulator in order to provide the actuation pressure to the hydraulic device.

### RELATED APPLICATIONS

This application is a continuation of international patent application PCT/EP2023/059865 filed on Apr. 17, 2023 claiming priority from German patent application DE 10 2022 109 462.6 filed on Apr. 19, 2022, both of which are incorporated in their entirety by this reference.

### FIELD OF THE INVENTION

The invention relates to a device and method for operating an electromagnetic rail brake, an electromagnetic rail brake, and a rail vehicle.

### BACKGROUND OF THE INVENTION

Electromagnetic rail brakes are suitable for different types of rail vehicles. They can be used e.g. as a supplement to other brake devices of the rail vehicles.

### BRIEF SUMMARY OF THE INVENTION

It is an object of the instant invention to provide an improved device and an improved method for operating an electromagnetic rail brake, an improved electromagnetic rail brake, and an improved rail vehicle.

The object is achieved by a device and a method for operating an electromagnetic rail brake, an electromagnetic rail brake and a rail vehicle according to the independent claims.

The object is achieved by A device configured to operate an electromagnetic rail brake of a rail vehicle, the rail vehicle comprising: the electromagnetic rail brake; and an additional brake device, the electromagnetic rail brake including: a brake magnet and a two stage suspension including a spring device configured to provide a spring force configured to counteract a weight force of the brake magnet, and a hydraulic device configured to move the brake magnet into a high position corresponding to a high suspension using an actuation pressure, the device including: a tank configured to store a hydraulic fluid or an interface to the tank, a pressure accumulator or an interface to the pressure accumulator, a pump device configured to the feed the hydraulic fluid from the tank to the pressure accumulator in order to load the pressure accumulator with a pressure a brake connection that is coupled or couplable with the pressure accumulator in order to provide a brake pressure for the additional brake device of the rail vehicle, and a suspension connection to the hydraulic device of the two stage suspension, wherein the suspension connection is coupled or couplable with the pressure accumulator to provide the actuation pressure to the hydraulic device.

The invention is particularly suitable for a rail vehicle which includes additional brake device in addition to the electromagnetic rail brake.

The rail vehicle can be a rail bound conveyance for transmitting goods or people. The additional brake device can be a hydraulicly activatable brake device, thus a hydraulic brake. The additional brake device can be used to brake a wheel or an axle of the rail vehicle in a known manner. The additional brake device can be configured as a disc brake or as a shoe brake. The electromagnetic rail brake can directly impact the rail like known electromagnetic rail brakes.

The electromagnetic rail brake can include a brake magnet and a two stage suspension. The two stage suspension facilitates to displace the brake magnet, typically in a vertical direction in order to be able to position the brake magnet at different distances from the rail. The electromagnetic rail brake can include a spring device that provides a spring force that acts opposite to a weight force of the brake magnet. Additionally the electromagnetic magnetic rail brake can include a hydraulic device configured to move the brake magnet using an operating pressure to move the brake magnet into an upper position in an overhead suspension. The brake magnet is moveable e.g. from a low position corresponding to a low suspension into the high position using the hydraulic device. In the low position of the brake magnet in a ready condition of the electromagnetic rail brake the brake magnet can be closer to the rail than in the high position. The spring device can include at least one spring, e.g. a coil spring. The hydraulic device can include at least one hydraulic cylinder. Using the spring device the brake magnet can be lifted off the rail after a brake application.

The electromagnetic rail brake can be advantageously operated using a device that is configured to provide an operating pressure for moving the brake magnet as well as a brake pressure for activating the additional brake device.

The device for operating the electromagnetic rail brake has the following features:
a tank configured to store a hydraulic fluid or an interface to the tank;
a pressure accumulator or an interface to the pressure accumulator;
a pump device configured to feed hydraulic fluid from the tank to the pressure accumulator and provide the pressure accumulator with pressure;
a brake connection connected or connectable with the pressure accumulator to provide a brake pressure for the additional brake device of the rail vehicle; and
a suspension connection to the hydraulic device of the two stage suspension, wherein the suspension connection is connected or connectable with the pressure accumulator to provide the operating pressure to the hydraulic device in a switchable manner.

The hydraulic fluid can be hydraulic oil. The pressure accumulator can be configured to store pressurized hydraulic fluid. The pressure accumulator can thus include at least one membrane accumulator that is formed in a known manner. The pump device can be a hydraulic pump that is known in the art. The brake connection can be flow connected with the pressure accumulator e.g. using a switch valve or can be cut off from the pressure accumulator as a function of a position of the switch valve. Accordingly, the suspension connection can be flow connected with the pressure accumulator as a function of a switch valve or cut off from the pressure accumulator. This way pressure stored in the pressure accumulator can be used for activating the additional brake device as well as for moving the brake magnet of the electromagnetic rail brake.

The device can include a switch valve configured to connect the suspension connection with the pressure accumulator in a first valve position and to separate the suspension connection from the pressure accumulator in a second of position. Thus, a nominal position of the brake magnet is adjustable by the valve device through corresponding control.

The valve device can be configured to connect the suspension connection with a tank return in the second valve position. This way an activation pressure can be established that impacts the hydraulic device.

The device can include a control connection configured to receive a control signal configured to switch the valve device between the first valve position and the second valve position. An electrical control signal is receivable through the control connection. This way the device is connectable to a brake control device of the rail vehicle.

The pressure accumulator can include a brake pressure accumulator and a suspension accumulator. Thus, the pump device can be configured to feed the hydraulic fluid from the tank to the brake pressure accumulator and the suspension accumulator in order to load the brake pressure accumulator and the suspension accumulator with the pressure. Accordingly the brake connection is connectable with the brake pressure accumulator and the suspension connection is connectable with the suspension accumulator in a switchable manner. Using two separate pressure accumulators helps to increase operational safety.

The device can include a check valve that can be arranged between the brake pressure accumulator and the suspension accumulator. This way a pressure drop from the suspension accumulator towards the brake pressure accumulator is preventable.

The device can include a drain valve that is connected between the suspension accumulator and the tank. The drain valve can be an automatically or manually activatable valve. The drain valve can facilitate a release of a pressure that is built up in the suspension accumulator, e.g. for performing maintenance.

A method for operating a magnetic rail brake and an additional brake device included in a rail vehicle comprises:
feeding hydraulic fluid from a tank to a pressure accumulator in order to load the pressure accumulator with pressure;
putting out a brake pressure for the additional brake device at a brake connection coupled with the pressure accumulator; and
switchable coupling of a suspension connection with the hydraulic device of the electromagnetic rail brake with the pressure accumulator in order to provide the activation pressure.

Steps of the method are advantageously implementable using arrangements of the device recited supra.

### BRIEF DESCRIPTION OF THE DRAWINGS

Embodiments of the invention will now be described with reference to drawing figures, wherein:

FIG. 1 shows a schematic view of a rail vehicle according to an advantageous embodiment;

FIG. 2 shows an electromagnetic rail brake according to an advantageous embodiment;

FIG. 3 shows a block diagram of a device for operating an electromagnetic rail brake according to an advantageous embodiment; and

FIG. 4 shows a flow diagram of a method for operating an electromagnetic rail brake according to an advantageous embodiment.

### DETAILED DESCRIPTION

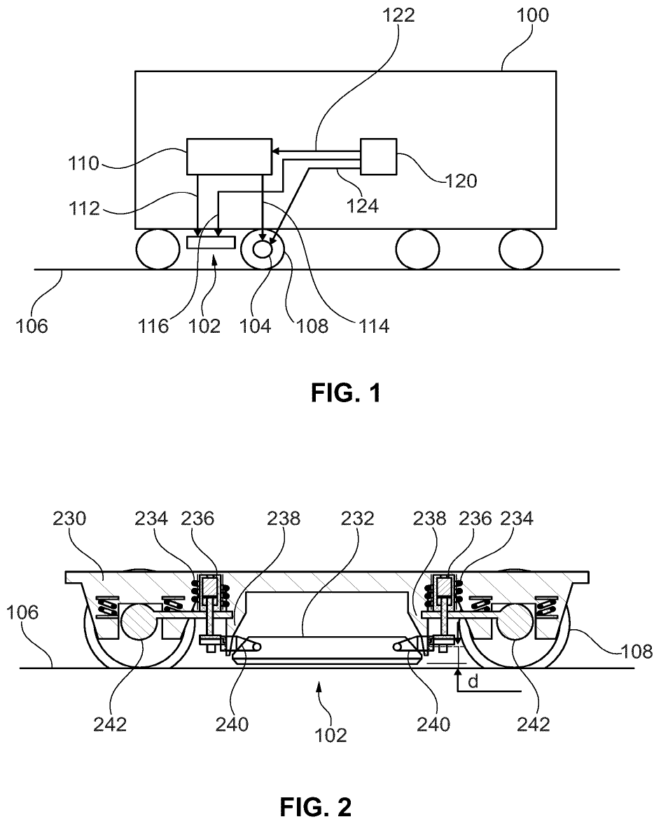

FIG. 1 shows a schematic view of a rail vehicle 100 according to an advantageous embodiment. The rail vehicle 100 includes at least one electromagnetic rail brake 102 and at least one additional brake device 104. In order to brake the rail vehicle 100 the electromagnetic rail brake 102 and additionally or alternatively the additional brake device 104 can be used. The electromagnetic rail brake 102 is configured to generate a brake force in cooperation with a rail 106, thus a rail 106 of a railroad track. The additional brake device 104 is configured to generate a brake force impacting a wheel 108 of the rail vehicle 100.

The electromagnetic rail brake 102 is operated using a device 110. The device 110 is configured to provide a hydraulic operating pressure 112 to a hydraulic device of the electromagnetic rail brake 102. The hydraulic device renders a position of a brake magnet of the electromagnetic rail brake 102 adjustable relative to the rail 106. Furthermore, the device 110 is configured to provide a brake pressure 114 for the additional brake device 104. The additional brake device 104 is activatable e.g. using the brake pressure 114.

A control current 116 is optionally provided to activate a coil of the brake magnet and generate a magnetic field. Using the control current 116 facilitates activating the electromagnetic rail brake 102 according to an advantageous embodiment, e.g. to implement an emergency brake request of a driver of the rail vehicle 100. The magnetic field facilitates pulling a brake magnet of the electromagnetic rail brake 102 towards the rail 106. When the control current 116 is not provided anymore the brake magnet of the electromagnetic rail brake 102 is liftable from the rail 106 using a spring device.

Optionally the device 110 is coupled with a brake control device 120. According to an advantageous embodiment the break control device 120 is used in order to control an operating condition of the electromagnetic rail brake 102 and of the additional brake device 104. Thus, the electromagnetic rail brake 102 and functions associated with the additional brake device 104 can be implemented separately within the brake control device 120 or implemented e.g. into separate break control devices. The brake control device 120 is configured e.g. to provide the control current 116 to activate the electromagnetic rail brake 102.

The brake control device 120 is configured e.g. to control a position of the brake magnet. Thus, the brake control device 120 is configured to provide an electrical control signal 122 for controlling the position of the brake magnet. The device 110 is configured according to an advantageous embodiment to control a valve device configured to provide the operating pressure 112 as a function of the control signal 122.

According to another advantageous embodiment the brake control device 120 is configured to control an activation and deactivation of the additional brake device 104, e.g. in order to implement a brake request of a driver of the rail vehicle 100. Thus, the brake control device 120 is configured e.g. to provide a brake signal 124 to the additional brake device 104 to control the additional brake device 104. The brake signal 124 is used e.g. to control a valve device that controls an application or non-application of the brake pressure 114 provided by the device 110 to an operating brake of the operating brake device 104.

The described feature is suitable for a mobile suspension for rail brakes which can thus be suspended in a low position as well as in a high position.

The magnetic rail brake 102 can be a rail brake that is typically used in light rail vehicles or trams, in full size rail vehicles like e.g. regional or intercity trains or increasingly also in so called train-train applications as an emergency brake. The electromagnetic rail brake 102 according to an advantageous embodiment includes at least one magnet and a suspension configured as an interface with the vehicle, thus the rail vehicle 100.

In particular electromagnetic rail brakes with a mechanical low suspension 8 mm to 12 mm above a top surface of the rail 106 are particularly suitable for light rail vehicles or trams. These brakes are configured for operations below 80 km/h on typical in town rail networks and very simple in configuration.

Electromagnetic rail brakes with high suspension 40 mm to 100 mm above the upper rail surface are suitable full size rail vehicles. These brakes can be used to up to 280 km/h.

Tram-train composites typically run a large portion of their travel path in town as a trams but can also run longer distances on full size rail tracks going to suburban terminals. This is challenging for the suspension due to very different requirements. Advantageously the magnetic rail brake 102 according to another embodiment is suitable for tram-trains and thus configured according to standards for in town and cross country use so that the brake can perform its emergency brake function under either condition.

According to an advantageous embodiment the rail vehicle 100 is e.g. a tram-train vehicle that is braked hydraulically. In order to save installation space and provide high power density, a compact hydraulic brake is selected more and more often that is included e.g. in the additional brake device.

Thus the electromagnetic rail brake 102 can be used as a low suspension rail brake and as a high suspension rail brake. Thus, the electromagnetic rail brake 102 is implemented in one embodiment as a rail brake with a two-stage hydraulic/mechanical suspension.

The suspension for the electromagnetic rail brake 102 is especially but not exclusively configured for an application in tram-train vehicles. According to an advantageous embodiment the suspension is configured so that the suspension works well in town and cross country. The electromagnetic rail brake 102 has to comply with typical requirements. These requirements typically include low weight, small installation space requirement in a suspension/bogie, quick buildup of brake force by quickly lowering the magnets to the rail 106, compatibility with requirements resulting from the vehicle environment (provided media for controlling force generation, electromagnetic compatibility with adjacent vehicle components), and compatibility with a surrounding rail infrastructure, electromagnetic compatibility with existing rail clearance reporting systems and light profiles.

The electromagnetic rail brake 102 does not limit a use of the rail vehicle 100 to specially qualified travel path sections. Thus, a high level of compatibility with the rail infrastructure and a high level of safety margin against incompatibility is provided.

Due to the hydraulic configuration compressed air in the bogie for pressurizing and venting pneumatic cylinders can be omitted. Additionally no installation space is required for connecting pneumatic cylinders. Since a compressed air supply can be omitted a weight of the suspension including its control can be kept low and a high drop velocity and thus quick response times can be provided. Thus, the electromagnetic rail brake 102 is also suitable for urban operation with very short emergency stop distances.

Using a two stage hydraulic/mechanical suspension also in tram-train vehicles facilitates omitting compressed air in the bogie for pressurizing and venting pneumatic ring suspension bags in an otherwise hydraulically braked vehicle which is an advantage over a pneumatic/hydraulic embodiment. Since no pneumatic ring suspension bags are required the installation space and the weight can be kept low and small while still achieving a high drop velocity and thus a short response time which renders the electromagnetic rail brake 102 suitable for urban operations with very short emergency brake distances.

The electromagnetic rail brake 102 for the rail vehicle 100 according to an advantageous embodiment has a compact, light and quickly responding hydraulic/mechanical suspension which fulfills the requirements of urban operations and cross country operations.

FIG. 2 shows an electromagnetic rail brake 102 according to an advantageous embodiment. The electromagnetic rail brake 102 is arranged at a frame 230 of a suspension of a rail vehicle illustrated in an exemplary manner in FIG. 1. The electromagnetic rail brake 102 includes a brake magnet 232 arrangeable in a two stage suspension in a low position as well as in a high position. The low position corresponds to a low suspension and the high position corresponds to a high suspension. Between the low position and the high position there is a distance d of a few millimeters or a few centimeters, advantageously of 6 mm to 40 mm.

The two stage suspension includes at least one spring device 234 configured to provide a spring force that counteracts the force of the brake magnet 232. The spring device 234 include e.g. at least one coil spring supported at the frame 230. The spring device 234 is coupled with the brake magnet 232 directly or through a suitable mechanism in order to pull the brake magnet 232 from the rail 106 against the weight force of the brake magnet 232 back into the low position when a coil of the brake magnet 232 is not provided with current anymore. Additionally the two stage suspension includes a hydraulic device 236 configured to move the brake magnet 232 into the high position using a hydraulic activation pressure. The activation pressure is provided e.g. using a device as described with reference to FIG. 1.

According to an advantageous embodiment the spring device 234 and the hydraulic device 236 form a two stage hydraulic and mechanical actuator.

The hydraulic device 236 includes e.g. the hydraulic cylinder that is movable by an activation pressure. When the spring device 234 is formed as a coil spring, the hydraulic cylinder can be enveloped by the coil spring which saves installation space. A piston of the hydraulic cylinder can be coupled with the brake magnet 232 directly or through a suitable mechanism in order to pull the brake magnet 232 from the low position into the high position.

The brake magnet 232 can be configured e.g. as a rigid magnet. Optionally the two stage suspension includes at least one support element 238 which is formed e.g. by the frame 230. The support element 238 is used e.g. for supporting a tension device 240 configured as a puller.

According to an advantageous embodiment the two stage suspension is coupled with an axle box 242.

According to an advantageous embodiment the two stage suspension incudes two spring devices 234 and two hydraulic devices 236 in order to be able to load the brake magnet 232 with a force on both sides. Optionally the two hydraulic devices 236 are connected in parallel and can thus be supplied with an activation pressure through a shared suspension connection.

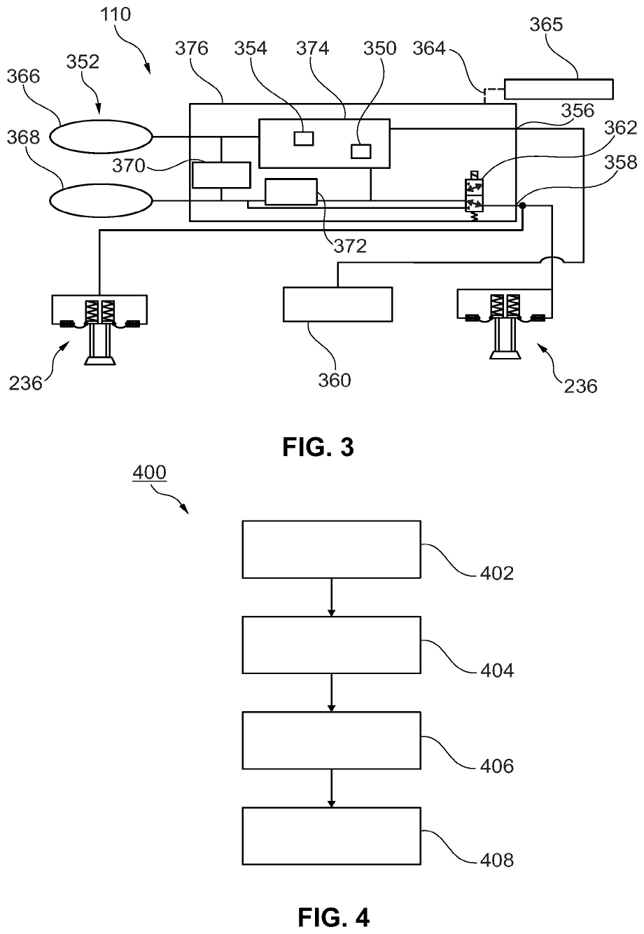

In order to hydraulically control the electromagnetic rail brake 102 in a two stage hydraulic/mechanical suspension a hydraulic device is improved in an advantageous embodiment in that an additional function of controlling an electromagnetic rail brake suspension is added in addition to the function for controlling hydraulic actuators of the rail vehicle or of a brake device of the rail vehicle. Thus, no separate hydraulic oil source is required for a rarely needed additional function of the brake system, namely lowering, and raising the electromagnetic rail brake 102 as an emergency brake. The block diagram in FIG. 3 shows the two functions.

FIG. 3 shows a block diagram of a device 110 according to an advantageous embodiment for operating an electromagnetic rail brake. This can be an electromagnetic rail brake as illustrated in FIG. 2. Only two hydraulic devices 236 of the electromagnetic rail brake are shown in FIG. 3. The device and the electromagnetic rail brake can be used e.g. for the rail vehicle described with reference to FIG. 1.

The device 110 includes a tank 350 for storing hydraulic fluid, a pressure accumulator 352, and a pump device 354. The pump device 354 is configured to feed hydraulic fluid from the tank 350 to the pressure accumulator 352 in order to load the pressure accumulator 352 with pressure. The device 110 furthermore includes a brake connection 356 and a suspension connection 358. A brake pressure for operating the additional brake device of the rail vehicle is put out through the brake connection 356 which is also designated as connection of the brake, thus e.g. to a passive force generator 360 of the additional brake device. The brake connection 356 is flow connected with the pressure accumulator 352 in order to put out the brake pressure. Optionally the brake pressure is always applied to the brake connection 356 when the pressure accumulator 352 is loaded with pressure. Alternatively, a switchable valve is provided to connect the brake connection 356 and the pressure accumulator 352 or to separate them. An activation pressure for activating at least one of the two hydraulic devices 236 is put out through the suspension connection 358 which is also designated as connection MG-suspension or LMg. The activation pressure is put out in a switchable manner, thus the pressure accumulator 352 and the suspension connection 358 are either flow connected in order to be able to put out the activation pressure through the suspension connection 358 or separated in order not to put out the activation pressure through the suspension connection 358. Using the activation pressure the hydraulic arrangements 236 can be activated so that a high suspension of the electromagnetic rail brake is achieved.

According to one embodiment the pressure accumulator is coupled with the suspension connection 358 through a switchable valve device 362. In one embodiment the valve device 362 is configured as a 3/2 way valve. In a first valve position, the valve device 362 is configured to connect the suspension connection 358 with the pressure accumulator 352. In a second valve position the valve device 362 is configured to separate the suspension connection 358 from the pressure accumulator 352. Optionally, the valve device 362 is configured to connect the suspension connection 358 with a tank return of the tank 350 in the second valve position.

Optionally the device 110 includes a control connection 364 configured to receive a control signal for switching the valve device 362 between the first valve position and the second valve position. The control signal is provided e.g. by switching logics 365. The switching logics 365 can be part of a brake control device.

According to one embodiment the pressure accumulator 352 includes a brake pressure accumulator 366 and a suspension accumulator 368. The brake pressure accumulator 366 provides a storage volume for a brake function and the suspension accumulator 368 provides a storage volume for the suspension of the electromagnetic rail brake. The pump device 354 is configured to feed hydraulic fluid from the tank 350 to the brake pressure accumulator 366 as well as to the suspension accumulator 368 in order to load the brake pressure accumulator 366 and the suspension accumulator 368 with the pressure. Accordingly the brake connection 356 is coupled with the brake pressure accumulator 366 in a switchable or non-switchable manner and the suspension connection 358 is coupled with the suspension accumulator 368 in a switchable manner.

According to an embodiment the device 110 optionally includes a check valve 370 that is connected between the brake pressure accumulator 366 and the suspension accumulator 368.

According to an embodiment the feed outlet of the pump device 354 is connected with the brake pressure accumulator 366 through a conduit and connected with the suspension accumulator 368 through another conduit in which the check valve 370 is arranged. This way the brake pressure accumulator 366 and the suspension accumulator 368 are fillable using a single pump of the pump device 354. The check valve 370 can be connected so that a pressure drop from the suspension accumulator 368 to the brake pressure accumulator 366 is prevented.

According to one embodiment the device 110 optionally includes a drain valve 372 configured e.g. as a hand valve that is connected between the suspension accumulator 368 and the tank 350.

In one embodiment the pump device 354 and the tank 350 form part of a hydro unit 374. Alternatively the tank 350 can be arranged in a different manner. According to one embodiment the hydro unit 374, the check valve 370, the drain valve 372 and the valve device 362 are designated as a hydro unit with an integrated brake and electromagnetic rail brake suspension function 376.

Optionally the device 110 only includes at least one interface to the pressure accumulator 352, so that the pressure accumulator 352 itself is not included in the device 110. The tank 350 can also be externally arranged relative to the device 110.

The recited units are connected with each other through suitable hydraulic conduits.

According to one embodiment a combined motor-pump arrangement in the hydro unit 374 generates an oil volume to be stored in the membrane accumulators (storage accumulators) provided per functional unit of the pressure accumulator 352. The hydro unit 374 optionally includes a pressure sensor which permanently monitors the pressure level e.g. in a range of 120 to 155 bar and controls the pump device 354 configured e.g. as the motor-pump combination by activating it as required.

According to one embodiment two membrane accumulator loops are provided and are functionally separated from each other by the check valve 70, so that a mutual interference of the systems is rendered impossible. The drain valve 372, herein configured as a hand valve is optionally provided for maintenance purposes or work at the hydraulic system that is without pressure, wherein the drain valve drains the stored oil volume into the tank 350 of the hydro unit upon activation.

The main function for controlling the elevation adjustment of the compression spring suspension is implemented according to one embodiment by using the valve device 362, thus a 3/2 way valve.

When tram-train vehicles are used as trams the low suspension is required so that a self-acting application to the rail is facilitated when activating the brake magnets with control current which builds up the deceleration force. For this purpose the valve device 362 configured as a 3/2 way valve according to one embodiment is not provided with voltage in order to provide the connection to the tank 350 or to the ambient atmosphere respectively. Gravity in combination with the function of the pressure suspension retains the brake magnets in the position of approximately 7 mm above the upper rail edge.

The high suspension is required when the tram-train is used as a train. Supplying voltage to the valve device 362, thus at the 3/2 way valve, releases a volume flow from the suspension accumulator 368, that is configured in an exemplary embodiment as a membrane accumulator, to the hydraulic devices 236, e.g. to compression spring actuation cylinders according to one embodiment and the suspension is moved into a position approximately 40 mm above the upper rail edge while driving. When a brake request is issued to the electromagnetic rail brake, control logics switch off voltage to the valve device 362, thus the 3/2 way valve according to an embodiment which moves the locked oil volume to the tank 350 and the brake magnet of the electromagnetic rail brake is lowered by gravity to 7 mm above the rail upper edge, so that a self-acting contact with the rail is enabled when activating the brake magnet or the brake magnets with control current which establishes the deceleration force configured to decelerate the rail vehicle.

According to one embodiment a function of the high suspension or the low suspension is implemented in control logics through a track detection in an automated manner, but also implemented manually.

Implementing the invention facilitates using only one pressure medium, e.g. hydraulic oil at the vehicle while simultaneously using the magnet and brake suspension function in compliance with various standard requirements.

In order to perform a safety brake function e.g. by triggering a push button provided for the driver or automatically by a dead man switch or a train influencing device or other superordinate system the safety brake function is implemented by using the electromagnetic rail brake by gravity dropping the brake magnet to 7 mm above the upper rail edge and controlling the electromagnetic rail brake 102 by the separate control current in an embodiment by deactivating the valve device 362, e.g. the 3/2 way valve.

The switching logics 365 for the magnetic rail brake 102 is configured as a separate control according to one embodiment in order to assure independence from the hydraulic brake function. The switching logics 365 according to another embodiment is expanded so that end position switches, pressure sensors or buffer switches can be read which monitor correct function or report to a super ordinant guidance system when there is a possibility of a malfunction in order to trigger predetermined subsequent actions or vehicle reactions.

According to another embodiment a permanent pressure drop in the system which indicates impermissible leakage is monitored by an optional monitoring of a run time of the pump device 354, e.g. the motor-pump combination in superordinate brake electronics and disclosed as well so that measures corresponding to the driver input like e.g. cutting off the affected guidance system can be used for deactivating the function.

It is a distinct advantage of the described application according to another embodiment that oil included in the vehicle and used as a medium for the brake system is used for the brake as well as for the pressure spring suspension. Thus no additional pneumatic loop is required. Additionally the limited installation situation is advantageous for hydraulic applications since little installation space is required. A quick reaction with respect to reducing the pressure of the smaller volume in order to provide quick lowering of the pressure spring actuators towards the upper rail edge and a resultant quicker response time until the brake force is available is another advantage.

FIG. 4 illustrates a block diagram of a method 400 for operating an electromagnetic rail brake according to an embodiment of the inventio. The steps of the method 400 can be implemented using a device as illustrated in FIG. 3.

Step 402 feeds hydraulic fluid to a pressure accumulator in order to load the pressure accumulator with the pressure. Step 404 puts out a brake pressure at a brake connection coupled with the pressure accumulator, wherein the brake pressure is configured to activate the additional brake device. Step 406 couples a suspension connection to the hydraulic device of the electromagnetic rail brake with the pressure accumulator in a switchable manner in order to provide the actuation pressure or not provide the actuation pressure. Optionally a step 408 provides a control current for activating the electromagnet of the electromagnetic rail brake. The steps 404, 406, 408 can be performed in random sequence and can be performed in parallel. Step 402 can also be performed permanently or as required, e.g. when the pressure of the pressure accumulator drops below a threshold value.

### REFERENCE NUMERALS AND DESIGNATIONS

100 rail vehicle
102 electromagnetic rail brake
104 additional brake device
106 rail
108 wheel
110 device
112 actuation pressure
114 brake pressure
116 control current
120 brake control device
122 control signal
124 brake signal
230 frame
232 brake magnet
234 spring device
236 hydraulic device
238 guide element
240 pull device
242 axle box
350 tank
352 pressure accumulator
354 pump device
356 brake connection
358 suspension connection
360 passive force generator
362 valve device
364 control connection
366 brake pressure accumulator
368 suspension accumulator
370 check valve
372 drain valve
374 hydro unit
376 hydro unit with integrated brake- and electromagnetic rail brake suspension function
400 method
402 feed step
404 output step
406 switchable coupling step
406 providing step

What is claimed is:

1. A device configured to operate an electromagnetic rail brake of a rail vehicle, the rail vehicle comprising:
the electromagnetic rail brake; and
an additional brake device,
the electromagnetic rail brake including: a brake magnet and a two stage suspension including a spring device configured to provide a spring force configured to counteract a weight force of the brake magnet, and
a hydraulic device configured to move the brake magnet into a high position corresponding to a high suspension using an actuation pressure,
the device including:
a tank configured to store a hydraulic fluid or an interface to the tank,
a pressure accumulator or an interface to the pressure accumulator,
a pump device configured to the feed the hydraulic fluid from the tank to the pressure accumulator in order to load the pressure accumulator with a pressure
a brake connection that is coupled or couplable with the pressure accumulator in order to provide a brake pressure for the additional brake device of the rail vehicle, and
a suspension connection to the hydraulic device of the two stage suspension, wherein the suspension connection is coupled or couplable with the pressure accumulator to provide the actuation pressure to the hydraulic device.

2. The device according to claim 1, further comprising:
a switchable valve device configured to connect the suspension connection with the pressure accumulator in a first valve position, and separate the suspension connection from the pressure accumulator in a second valve position.

3. The device according to claim 2, wherein the switchable valve device is configured to connect the suspension connection with a tank return of the tank in the second valve position.

4. The device according to claim 2, further comprising: a control connection configured to receive a control signal configured to switch the switchable valve device between the first valve position and the second valve position.

5. The device according to claim 1,
wherein the pressure accumulator includes a brake pressure accumulator and a suspension accumulator,
wherein the pump device is configured to feed the hydraulic fluid out of the tank to the brake pressure accumulator and the suspension accumulator to load the brake pressure accumulator and the suspension accumulator with the pressure,
wherein the brake connection is couplable with the brake pressure accumulator, and
wherein the suspension connection is couplable with the suspension accumulator in a switchable manner.

6. The device according to claim 5, further comprising: a check valve connected between the brake pressure accumulator and the suspension accumulator.

7. The device according to claim 5, further comprising: a drain valve connected between the suspension accumulator and the tank.

8. An electromagnetic rail brake for a rail vehicle including the electromagnetic rail brake and an additional brake device,
wherein the electromagnetic rail brake includes a brake magnet and a two stage suspension including a spring device configured to provide a spring force configured to counteract a weight force of the brake magnet, and a hydraulic device configured to move the brake magnet into a high position corresponding to a high suspension using an actuation pressure, and the device according to claim 1 configured to operate the electromagnetic rail brake.

9. A rail vehicle including the electromagnetic rail brake according to claim 8 and the additional brake device.

10. A method for operating an electromagnetic rail brake for a rail vehicle including the electromagnetic rail brake and an additional brake device,
wherein the electromagnetic rail brake includes a brake magnet and a two stage suspension including a spring device configured to provide a spring force configured to counteract a weight force of the brake magnet, and a hydraulic device configured to move the brake magnet into a high position corresponding to a high suspension using an actuation pressure, the method comprising:
feeding a hydraulic fluid from a tank to a pressure accumulator to load the pressure accumulator with the pressure;
putting out a brake pressure for the additional brake device to a brake connection coupled with the pressure accumulator; and
switchable coupling of a suspension connection of the hydraulic device of the electromagnetic rail brake with the pressure accumulator to provide the actuation pressure.
